(19) United States
(12) Patent Application Publication
(10) Pub. No.: US 2008/0052866 A1
(43) Pub. Date: Mar. 6, 2008

(54) Wiper arm and vehicle wiper

(75) Inventors: Hiroshi Matsumoto, Hamamatsu-city (JP); Takashi Umeno, Kosai-city (JP); Yuta Doi, Toyohashi-city (JP)

Correspondence Address: POSZ LAW GROUP, PLC, 12040 SOUTH LAKES DRIVE, SUITE 101, RESTON, VA, 20191, US

(73) Assignee: ASMO CO., LTD., Kosai-city (JP)

(21) Appl. No.: 11/889,803

(22) Filed: Aug. 16, 2007

(30) Foreign Application Priority Data
Sep. 5, 2006 (JP) JP2006-240043
Sep. 13, 2006 (JP) JP2006-248417
Dec. 27, 2006 (JP) JP2006-353219

(51) Int. Cl. B60S 1/34

(52) U.S. Cl. 15/250.351

(57) ABSTRACT

An arm main body is rotatably connected to an arm head. A spring urges a distal end portion of the arm main body toward a wiping surface to urge a wiper blade toward the wiping surface. The arm main body includes a receiving recess, which receives the spring and the arm head. The spring is placed on a side of a fixing portion of the arm head where the distal end portion of the arm main body is located. The arm main body is rotatably connected to the arm head at a location that is spaced from the spring on a side opposite from the distal end portion of the arm main body.

### CROSS REFERENCE TO RELATED APPLICATION

This application is based on and incorporates herein by reference Japanese Patent Application No. 2006-240043 filed on Sep. 5, 2006, Japanese Patent Application No. 2006-248417 filed on Sep. 13, 2006 and Japanese Patent Application No. 2006-353219 filed on Dec. 27, 2006.

### BACKGROUND OF THE INVENTION

1. Field of the Invention

The present invention relates to a wiper arm and a vehicle wiper having the same.

2. Description of Related Art

In a wiper arm of a vehicle wiper, an arm main body (a retainer) is rotatably connected to an arm head, which is fixed to a pivot shaft of a vehicle, through a pin member (a hinge pin), as recited in, for example, Japanese Utility Model Publication No. S61-27755. Furthermore, the arm main body has an inverted U-shaped cross section that opens on the wiping surface side, and an urging spring (a compression coil spring) is received in the interior space of the arm main body. The spring urges the arm main body toward the wiping surface side to urge the wiper blade, which is attached to a distal end portion of the arm main body, against the wiping surface. The spring is received over a rod, and one end of the rod is connected to the arm main body through a pin member (a pin).

However, in the case of Japanese Utility Model Publication No. S61-27755, the arm main body is connected to a distal end portion of the arm head, so that a connection between a base end portion of the arm head and the pivot shaft is externally exposed to deteriorate the external appearance of the wiper.

In a case of a wiper arm recited in Japanese Unexamined Patent Publication No. H05-319215 (corresponding to U.S. Pat. No. 5,222,274), an arm head is received in an arm main body (shroud) to limit external exposure of the connection between the arm head and the pivot shaft.

However, in the wiper arm recited in Japanese Unexamined Patent Publication No. H05-319.215, although the external exposure of the connection between the arm head and the pivot shaft is limited by the arm main body (the shroud), an urging spring is placed to extend above the pivot shaft, so that a space to place the spring above the pivot shaft needs to be provided in the arm main body. Thus, the height of the arm main body is disadvantageously increased.

### SUMMARY OF THE INVENTION

The present invention addresses the above disadvantages. Thus, it is an objective of the present invention to provide a wiper arm, which limits external exposure of a connection between a pivot shaft and the wiper arm and minimizes a height of the wiper arm to implement a relatively low profile of the wiper arm. It is another objective of the present invention to provide a vehicle wiper that includes such a wiper arm.

To achieve the objectives of the present invention, there is provided a wiper arm that includes an arm head, an arm main body and an urging means. The arm head is adapted to be fixed to a pivot shaft of a vehicle through a fixing portion of the arm head. The arm main body is rotatably connected to the arm head at a base end portion of the arm main body and is adapted to be connected with a wiper blade for wiping a wiping surface at a distal end portion of the arm main body. The urging means is for urging the distal end portion of the arm main body toward the wiping surface. The urging means is provided between the arm head and the arm main body. The arm main body includes a receiving recess, which receives the urging means and the arm head. The urging means is placed on a side of the fixing portion of the arm head where the distal end portion of the arm main body is located upon installation of the urging means and the arm head in the receiving recess of the arm main body. The arm main body is rotatably connected to the arm head at a location that is spaced from the urging means on a side opposite from the distal end portion of the arm main body.

To achieve the objectives of the present invention, there is also provided a wiper arm that includes an arm head, an arm outer shell forming member and an arm mechanism arrangement. The arm head is adapted to be fixed to a pivot shaft of a vehicle through a fixing portion of the arm head. The arm outer shell forming member has a receiving recess, which receives the arm head. The arm outer shell forming member is adapted to be connected with a wiper blade for wiping a wiping surface at a distal end portion of the arm outer shell forming member. The arm mechanism arrangement is received in the receiving recess of the arm outer shell forming member together with the arm head. The arm mechanism arrangement includes a bracket and an urging means. The bracket is rotatably connected to the arm head through a connecting member. The urging means is for urging the distal end portion of the arm outer shell forming member toward the wiping surface. The urging means is placed between the arm head and a predetermined portion of the bracket in such a manner that the urging means is placed on a side of the fixing portion of the arm head where the distal end portion of the arm main body is located. The arm outer shell forming member is connected to the bracket to follow movement of the arm mechanism arrangement while the arm mechanism arrangement and the arm head are received in the receiving recess. The arm outer shell forming member is rotatably connected to the arm head at a location that is spaced from the urging means on a side of the urging means, which is opposite from the distal end portion of the arm main body.

To achieve the objectives of the present invention, there is also provided a vehicle wiper that includes the wiper arm described above and a wiper blade. The wiper blade is connected to the distal end portion of the arm outer shell forming member of the wiper arm to wipe the wiping surface.

### BRIEF DESCRIPTION OF THE DRAWINGS

The invention, together with additional objectives, features and advantages thereof, will be best understood from the following description, the appended claims and the accompanying drawings in which:

FIG. 1 is a partially fragmented plan view of a wiper arm according to a first embodiment of the present invention;

FIG. 2 is a longitudinal cross sectional view of the wiper arm according to the first embodiment;

FIG. 3 is a side view of a base end portion of the wiper arm according to the first embodiment;

FIG. 4 is a partially fragmented plan view of the wiper arm according to a second embodiment of the present invention;

FIG. 5 is a longitudinal cross sectional view of the wiper arm according to the second embodiment;

FIG. 6 is an exploded perspective view of the wiper arm according to the second embodiment;

FIG. 7 is a lateral cross sectional view of the wiper arm according to the second embodiment; and

FIG. 8 is a cross sectional view of a modification of the base end portion of the wiper arm.

### DETAILED DESCRIPTION OF THE INVENTION

### First Embodiment

A first embodiment of the present invention will be described with reference to the accompanying drawings.

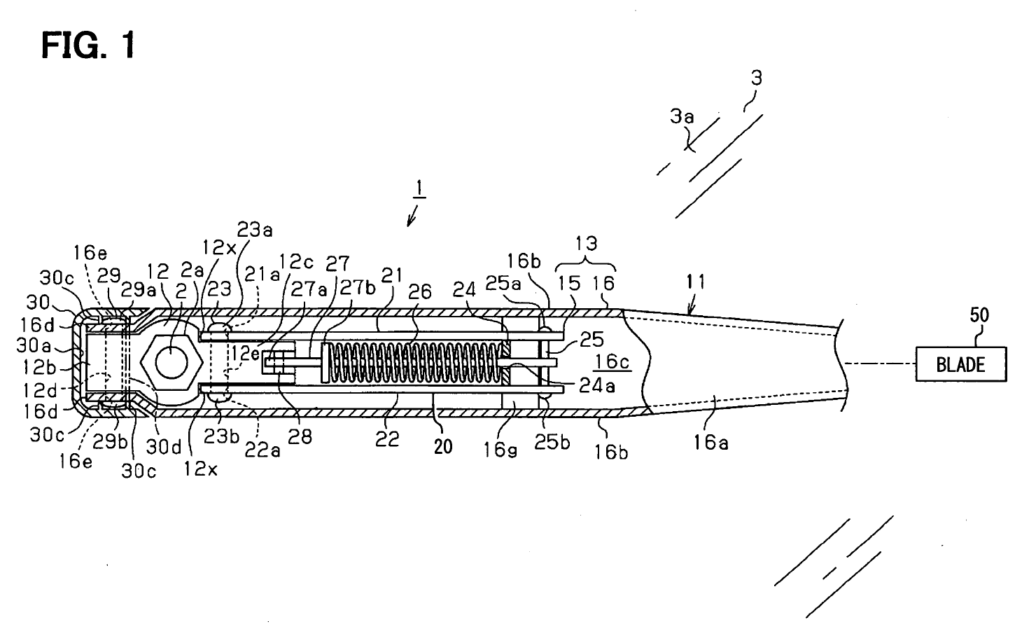

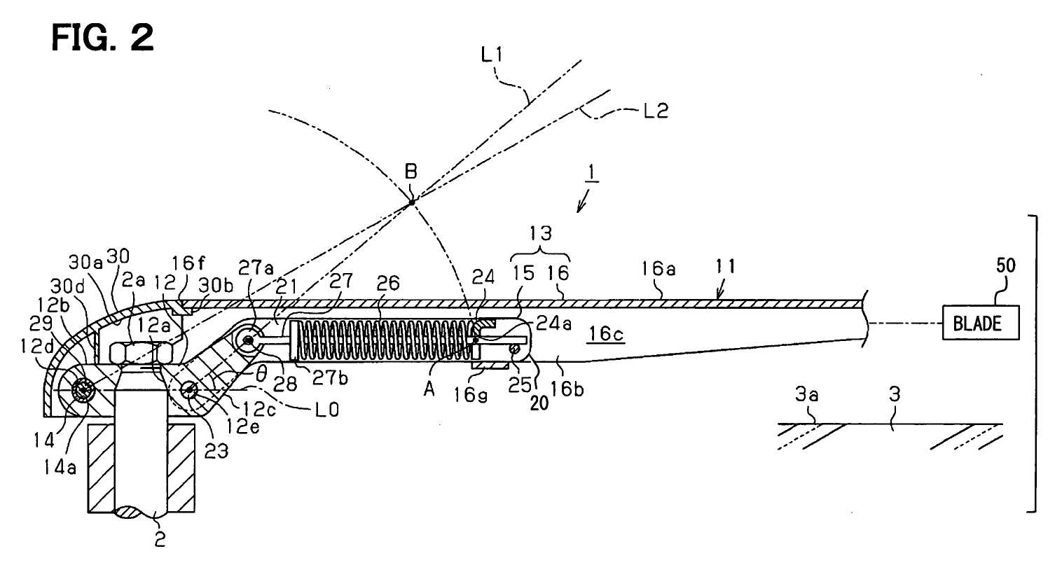

FIGS. 1 and 2 show a wiper 1 of a vehicle according to the present embodiment. The wiper 1 of the present embodiment includes a wiper arm 11 and a wiper blade 50. A base end portion of the wiper arm 11 is fixed to a pivot shaft 2, which is provided at a location around a lower end of a front glass 3 of the vehicle. The wiper blade 50 is rotatably connected to a distal end portion of the wiper arm 11. The wiper 1 wipes a wiping surface 3a of the front glass 3 when the wiper 1 is reciprocally swung by the pivot shaft 2, which is reciprocally rotated by a wiper motor (not shown).

The wiper arm 11 includes an arm head 12 and an arm main body 13. The arm main body 13 is rotatably connected to the arm head 12 thorough a connecting shaft (a connecting pin 23), which extends generally parallel to the wiping surface 3a.

The arm head 12 includes a fixing hole 12a at its center to fix the pivot shaft 2 therethrough. Specifically, a distal end portion of the pivot shaft 2 is received through the fixing hole 12a and is fixed to the arm head 12 upon tightening a nut 2a over the threaded distal end portion of the pivot shaft 2. A base end portion of the arm head 12 forms a base end connecting portion 12b, which is connected to an arm outer shell 16 of the arm main body 13. Furthermore, a distal end portion of the arm head 12 forms a distal end connecting portion 12c, which is connected to an arm mechanism arrangement 15 of the arm main body 13.

A connecting hole 12d is formed to extend through the base end connecting portion 12b in a width direction of the base end connecting portion 12b and has a circular cross section. The connecting hole 12d is provided to connect with the arm outer shell 16, and a cylindrical bearing 14 is fixed to an inner peripheral surface of the connecting hole 12d to enable smooth rotation of the arm outer shell 16.

A distal end side of the distal end connecting portion 12c extends obliquely upwardly on a side opposite from the wiping surface 3a. A connecting hole 12e is formed to extend through a base end side (a fixing hole 12a side) of the distal end connecting portion 12c in a width direction of the distal end connecting portion 12c. The connecting hole 12e is used to rotatably connect with the arm mechanism arrangement 15. A center axis of the connecting hole 12e and a center axis of the connecting hole 12d (as well as a center axis of a receiving hole 14a in the bearing 14) are all located in a common plane that extends in a direction perpendicular to an axis of the pivot shaft 2.

The arm main body 13 includes the arm mechanism arrangement 15, the arm outer shell 16 and a cover 30. The arm mechanism arrangement 15 forms a mechanical part of the arm main body 13. The cover 30 receives and covers the arm head 12. Furthermore, the cover 30 defines an outer configuration or shape of the arm main body 13 in corporation with the arm outer shell 16. Here, the arm outer shell 16 and the cover 30 form an arm outer shell forming member.

The arm mechanism arrangement 15 includes a bracket 20 that has two bracket plates 21, 22, which are formed separately. Each bracket plate 21, 22 is made of a plate material and is bent into a dogleg shape. Specifically, a base end portion of the bracket plate 21, 22 is bent downward at a location that is on a base end side of a longitudinal center of the bracket plate 21, 22. A connecting hole 21a, 22a, which has a circular cross section, extends through the base end portion of each bracket plate 21, 22 in a plate thickness direction of the bracket plate 21, 22 to correspond with the connecting hole 12e of the distal end connecting portion 12c. A generally cylindrical connecting pin 23 is inserted through and is supported in each of these connecting holes 21a, 22a, 12e while the base end portions of the bracket plates 21, 22 are placed on two opposed lateral sides, respectively, of the distal end connecting portion 12c of the arm head 12. A head 23a is formed at one end of the connecting pin 23. Upon insertion of the connecting pin 23 through the connecting holes 21a, 22a, 12e, the other end of the connecting pin 23 is clinched to form a clinched part 23b and thereby to limit removal of the connecting pin 23 from the connecting holes 21a, 22a, 12e. In this way, the base end portion of each bracket plate 21, 22 is rotatably connected to the distal end connecting portion 12c of the arm head 12 through the connecting pin 23.

A stopper (stopper portion) 24 and a connecting pin 25 are installed to distal end portions of the bracket plates 21, 22 in the bracket 20. The stopper 24 and the connecting pin 25 support a spring guide 27 described below and connect between the bracket plates 21, 22 while maintaining a parallel relationship of the bracket plates 21, 22 and a space between the bracket plates 21, 22. The stopper 24 includes a slit 24a, which is recessed from a lower side (a wiping surface 3a side) toward an upper side. Two opposed lateral sides of the stopper 24 are fixed to inner surfaces, respectively, of the bracket plates 21, 22 by, for example, welding. The connecting pin 25, which has a generally cylindrical shape, is inserted and is held through a distal end side part of each bracket plate 21, 22, which is on a distal side of the stopper 24. At this time, a head 25a of the connecting pin 25 at one end thereof and a clinched part 25b at the other end thereof are placed at outer surfaces, respectively, of the distal end portions of the bracket plates 21, 22.

An urging coil spring 26 and the spring guide 27 are placed between the bracket plates 21, 22. The spring guide 27 is generally rod-shaped and supports the spring 26. A connecting portion 27a, which is provided at a base end portion of the spring guide 27, is rotatably connected to the distal end connecting portion 12c of the arm head 12 through an anchoring pin 28. The anchoring pin 28 is installed to the distal end connecting portion 12c of the arm head 12 at a location that is on an upper side of the connecting hole 12e, which receives the connecting pin 23, in such a manner that the anchoring pin 28 is parallel with the connecting pin 23.

An annular flange 27b is provided at a predetermined base end location of the spring guide 27. The urging spring 26 is received and is supported over the spring guide 27 on a distal side of the flange 27b. A distal end portion of the spring guide 27 is received into the slit 24a of the stopper 24 and is placed on the connecting pin 25 after the installation of the connecting pin 25, which is installed after the installation of the distal end portion of the spring guide 27 into the slit 24a of the stopper 24. Thus, the spring 26 is installed in a compressed state between the flange 27b and the stopper 24. That is, the distal end portion of the spring guide 27 is limited by the connecting pin 25 from moving downward, i.e., moving out of the slit 24a of the stopper 24. The sprig 26, which is installed in the compressed state between the flange 27b of the spring guide 27 and the stopper 24, exerts an urging force to urge the distal end portions of the bracket plates 21, 22 toward the wiping surface 3a side and thereby to urge the bracket plates 21, 22, which is pivoted about the connecting pin 23, toward the wiping surface 3a side. In other words, the spring 26 exerts the urging force to urge the distal end portion of the arm main body 13 (the distal end portion of the arm outer shell 16) toward the wiping surface 3a side to urge the wiper blade 50, which is connected to the distal end portion of the arm main body 13, toward the wiping surface 3a side.

Then, the arm outer shell 16 is placed to cover the arm mechanism arrangement 15 and is fixed to the arm mechanism arrangement 15. A predetermined part in the base end portion of the arm outer shell 16 has a generally inverted U-shaped cross section, which is opened downward (toward the wiping surface 3a side). The arm outer shell 16 is tapered toward the distal end portion where the wiper blade 50 is connected to wipe the wiping surface 3a.

The base end portion of the arm outer shell 16 includes a top wall 16a and two lateral walls 16b. The lateral walls 16b extend downward from lateral edges, respectively, of the top wall 16a. The top wall 16a and the lateral walls 16b define a receiving recess 16c, which receives the arm mechanism arrangement 15.

A connecting piece 16d is formed in the base end portion of each lateral wall 16b to extend from the lateral wall 16b. A connecting hole 16e extends through each connecting piece 16d in a plate thickness direction thereof. The connecting hole 16e has a circular cross section and corresponds with the receiving hole 14a of the bearing 14. The connecting pieces 16d are placed at two lateral sides, respectively, of the base end connecting portion 12b. A generally cylindrical connecting pin 29 is inserted through each connecting hole 16e and the receiving hole 14a to hold the connecting pieces 16d relative to the base end connecting portion 12b of the arm head 12. A head 29a is formed at one end of the connecting pin 29. Upon insertion of the connecting pin 29 through the connecting holes 16e and the receiving hole 14a, the other end of the connecting pin 29 is clinched to form a clinched part 29b and thereby to limit removal of the connecting pin 29. In this way, the connecting pieces 16d of the base end portion of the arm outer shell 16 is rotatably connected to the base end connecting portion 12b of the arm head 12 through the connecting pin 29.

An opening 16f is formed in the top wall 16a between the connecting pieces 16d to expose the center portion and the base end portion of the arm head 12, i.e., to expose the distal end portion (nut 2a) of the pivot shaft 2, which is fixed to the arm head 12. The opening 16f is configured such that the nut 2a is installable and removal with respect to the pivot shaft 2 from the top side of the arm outer shell 16 after the arm outer shell 16 is connected to the arm head 12 through the connecting pin 29.

A pressure receiving portion 16g, which is formed into a planar plate shape, is bent at a lower edge of the lateral wall 16b to extend in a width direction of the arm outer shell 16. The pressure receiving portion 16g is engaged with a lower end of the distal end portion of each bracket plate 21, 22. Alternatively, two pressure receiving portions 16g may be provided at the lower edges of the lateral walls 16b, respectively, and may be bent toward each other in the width direction. Each bracket plate 21, 22 is pivoted about the connecting pin 23 at the base end portion of the bracket plate 21, 22 and is urged by the urging force of the spring 26 toward the wiping surface 3a side. The urging force is received by the pressure receiving portion 16g of the arm outer shell 16. In this way, the distal end portion of the arm outer shell 16 is urged toward the wiping surface 3a side to urge the wiper blade 50, which is connected to the distal end portion of the arm outer shell 16, toward the wiping surface 3a side.

In the present embodiment, a line L0, which extends through a center axis of the connecting pin 23 and is perpendicular to the axis of the pivot shaft 2, defines an angle θ relative to a line L1, which extends through a center axis of the anchoring pin 28 and also a rotational center of the arm mechanism arrangement 15. This angle θ is set to be relatively large and is set to an appropriate angle through simulation. More specifically, this angle θ is set to implement the efficient conversion of the urging force of the urging spring 26 to the urging force directed toward the wiping surface 3a side, and a size of the urging spring 26 is minimized.

Furthermore, with reference to FIG. 2, the spring 26 is compressed at the maximum degree when the arm main body 13 is pulled upward to rotate the arm mechanism arrangement 15 about the rotational axis (about the connecting pin 23) in such a manner that a point A, which receives the load from the spring 26 on the side opposite from the rotational axis (the connecting pin 23), is placed at a point B that exists on the line L1. Also, at this time, the lift angle (rocking back angle) of the arm outer shell 16, i.e., the lift angle of the line L2, which connects between the center axis of the connecting pin 29 and the point A, is smaller than the lift angle of the arm mechanism arrangement 15. Furthermore, when the arm main body 13 is further lifted beyond the point B, the point B becomes a change point, beyond which the urging force of the spring 26 is changed to exert its force in the lifting direction of the arm main body 13. Then, each bracket plate 21, 22 of the arm mechanism arrangement 15 is engaged with a stepped surface 12x of the arm head 12 shown in FIG. 1 to limit further lifting of the arm main body 13 to maintain the lifted position of the arm main body 13.

The cover 30 is installed to the base end portion of the arm outer shell 16. The cover 30 has an outer surface, which is continuous with an outer surface (design surface) of the arm outer shell 16. Furthermore, the cover 30 closes the opening 16f. Thus, the arm head 12 and the connecting pieces 16d of the arm outer shell 16 are received in a receiving recess 30a of the cover 30 and are thereby covered with the cover 30. The cover 30 includes an anchoring projection 30b and two fitting portions 30c. The anchoring projection 30b is engaged to and is thereby anchored to an inner surface of the base end portion of the top wall 16a of the arm outer shell 16 (inner surface of the opening 16f). The fitting portions 30c are provided in the inner surface of the receiving recess 30a to engage with the lateral surfaces, respectively, of the arm head 12 in such a manner that the fitting portions 30c surround the head 29a and the clinched part 29b, respectively, of the connecting pin 29. The anchoring projection 30b of the cover 30 is engaged with the inner surface of the base end portion of the top wall 16a, and the fitting portions 30c of the cover 30 are engaged with the head 29a and the clinched part 29b, respectively, of the connecting pin 29. In this way, the cover 30 is detachably installed to the arm outer shell 16 and the connecting pin 29. The cover 30 limits external exposure of the arm head 12 and the connecting pieces 16d of the arm outer shell 16. That is, the cover 30 limits external exposure of the distal end portion of the pivot shaft 2 and the nut 2a as well as the head 29a and the clinched part 29b of the connecting pin 29.

A partition wall 30d is provided in an inner surface of the receiving recess 30a of the cover 30 to extend in the width direction at an intermediate location between the pivot shaft 2 (the nut 2a) and the connecting pin 29 to partition the receiving recess 30a of the cover 30. The partition wall 30d limits intrusion of, for example, rain water through a gap between the opening 16f of the arm outer shell 16 and the cover 30 toward the connecting pin 29 side. In addition, the fitting portions 30c surround the head 29a and the clinched portion 29b, respectively, of the connecting pin 29 to limit intrusion of, for example, the rain water into the connection, where the connecting pin 29 is provided.

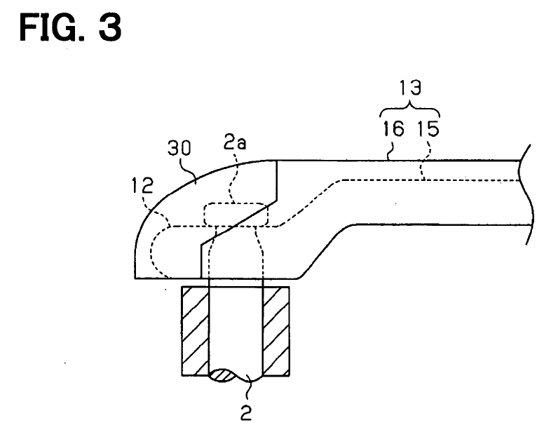

The arm mechanism arrangement 15 is formed as a pseudo-arm. The arm outer shell 16 and the cover 30, which are formed to provide good design appearance, are integrally installed to the arm mechanism arrangement 15 that is formed as the pseudo-arm. Thus, the arm mechanism arrangement 15 and the arm head 12 are covered with the arm outer shell 16 and the cover 30 to improve the external design appearance, and the rigidity of the wiper arm 11 is improved. Specifically, the arm mechanism arrangement 15, which serves as the pseudo-arm, is received in the receiving recess 16c of the arm outer shell 16, and the arm mechanism arrangement 15 is fixed in the interior of the arm outer shell 16. In the interior of the cover 30, which defines the outer shape of the arm main body 13 in corporation with the arm outer shell 16, the arm head 12 is connected to the arm outer shell 16, and the arm head 12 is fixed to the pivot shaft 2. Thus, external exposure of, for example, each connecting pin 23, 25, which is installed to the arm mechanism arrangement 15, can be limited. Also, external exposure of the connecting pin 29, which is used to connect the arm outer shell 16, is limited. Furthermore, external exposure of the distal end portion of the pivot shaft 2 and the nut 2a is limited. Thereby, as shown in FIG. 3, only the outer surfaces (design surfaces) of the arm outer shell 16 and the cover 30 are externally exposed in the arm main body 13. In this way, the external appearance of the arm main body 13, i.e., the external appearance of the wiper arm 11 is improved according to the present embodiment. Furthermore, in the arm main body 13, the arm mechanism arrangement 15 is received in the receiving recess 16c of the arm outer shell 16. Thus, the rigidity of the wiper arm 11 is further improved.

Furthermore, the arm outer shell 16, to which the wiper blade 50 is connected at the distal end portion thereof, is connected to the arm head 12 by the connecting pin 29. Also, the arm mechanism arrangement 15, to which the urging force of the spring 26 is applied, is connected to arm head 12 by the connecting pin 23, which is different from the connecting pin 29. Thus, the spring load and the wiping load, which are supported by the single shaft in the previously proposed technique, can be spread between the shaft (the connecting pin 23), which receives the spring load, and the shaft (the connecting pin 29), which receive the wiping load. Furthermore, the durability of each of the connecting pins 23, 29, which serve as the connecting members, can be improved without increasing the strength thereof, so that the durability of the wiper arm 11 can be improved.

Furthermore, the arm mechanism arrangement 15 is formed as the pseudo-arm and is constructed separately from the arm outer shell 16. Thus, the position of the rotatable shaft (connecting pin 29) of the arm outer shell 16 relative to the arm head 12 can be set regardless of the positional relationship of the shafts, which are important in the setting of the rocking back angle and the urging force, i.e., regardless of the relationship between the connecting pin 23 and the anchoring pin 28.

Next, the advantages of the present embodiment will be described.

(1) The arm main body 13 of the present embodiment is rotatably connected to the arm head 12 through the connecting pin 29 in such a manner that the spring 26 and the arm head 12 are received in the arm main body 13, more specifically, in the receiving recess 16c of the arm outer shell 16 and the receiving recess 30a of the cover 30, and the fixing portion (the fixing hole 12a), to which the pivot shaft 2 is fixed, is covered with the arm main body 13, more specifically, with the arm outer shell 16 and the cover 30. In this way, the external exposure of the fixing portion, to which the pivot shaft 2 is fixed, is limited by the arm main body 13, and the spring 26 is placed without extending above the pivot shaft 2. Therefore, the height of the arm main body 13 is limited to implement the low profile of the arm main body 13. Therefore, the external appearance of the wiper 1 is improved.

(2) In the arm main body 13 of the present embodiment, the spring guide 27, which supports the spring 26, is fixed in place by the connecting pin 25, and the arm mechanism arrangement 15, which is rotatably connected to the arm head 12 through the connecting pin 23, is formed separately from the arm outer shell forming member, which includes the arm outer shell 16 and the cover 30. Furthermore, the arm mechanism arrangement 15 and the arm head 12 are received in the receiving recess 16c of the arm outer shell 16 and the receiving recess 30a of the cover 30. Also, in order to follow the movement of the arm mechanism arrangement 15, the arm outer shell 16 is fixed to the arm mechanism arrangement 15 and is rotatably connected to the arm head 12. Specifically, in the arm main body 13, the arm mechanism arrangement 15 and the arm head 12 are received in the arm outer shell 16 and the cover 30. The arm mechanism arrangement 15 is connected to the arm head 12 and the spring guide 27 through the connecting pins 23, 25. The arm head 12 is fixed to the pivot shaft 2. That is to say, it is limited to externally expose crowded parts or visually undesirably parts of the arm mechanism arrangement 15 and the arm head 12, specifically, the heads 23a, 25a, 29a and the clinched parts 23b, 25b, 29b of the connecting pins 23, 25, 29. In this way, the external appearance of the wiper arm 11 is improved.

(3) In the present embodiment, the spring 26 is installed in the compressed state between the arm head 12 and the arm main body 13. Thus, it is not required to provide a known hook member (not shown), which is otherwise required to move or relief the rotatable shaft (the connecting pin 23) between the arm head 12 and the arm main body 13 toward the wiping surface 3a side in a case where a tension spring, which is installed in a tensed state, is used as the urging spring in stead of the compression spring. That is, according to the present embodiment, the profile of the wiper arm 11 can be reduced by the amount, which corresponds to a size of such a known hook member.

(4) In the arm mechanism arrangement 15 of the present embodiment, the two bracket plates 21, 22, which are arranged on the opposed lateral sides, respectively, of the distal end connecting portion 12c of the arm head 12, are connected to the arm head 12 through the connecting pin 23, and the two bracket plates 21, 22 are connected together through the connecting pin 25 at the distal end portions thereof. That is, the two bracket plates 21, 22, i.e., the plate-shaped members are used to form the bracket 20 of the arm mechanism arrangement 15, so that the arm mechanism arrangement 15 can be formed to have the relatively light weight at relatively low costs. Furthermore, in the present embodiment, the two bracket plates 21, 22 are connected together through the connecting pins 23, 25, which are used to connect the arm head 12 and the spring guide 27. Thus, the number of components and the number of assembling steps can be reduced.

(5) In the arm mechanism arrangement 15 of the present embodiment, the spring 26 and the spring guide 27 are placed between the bracket plates 21, 22. That is, the bracket plates 21, 22 are provided on the opposed lateral sides, respectively, of the distal end connecting portion 12c of the arm head 12. Therefore, the space, which corresponds to the distal end connecting portion 12c, is formed between the bracket plates 21, 22. That is, the spring 26 and the spring guide 27 are placed in this space to effectively use the widthwise space of the arm mechanism arrangement 15, and interferences between the bracket plates 21, 22 and the spring 26 as well as the spring guide 27 are effectively limited. Even in this way, the profile of the wiper arm 11 can be reduced.

(6) In the present embodiment, the urging force, which is exerted from the arm mechanism arrangement 15 toward the wiping surface 3a side by the spring 26, is received by the pressure receiving portion 16g, which is provided at the receiving recess 16c of the arm outer shell 16 (at the lower edges of the lateral walls 16b). Thus, the arm main body 13 can be urged toward the wiping surface 3a side without externally exposing a fixture, which is used to fix the pressurizing structure, on the outer surface of the arm outer shell 16. In this way, the external appearance of the wiper arm 11 can be improved.

(7) In the present embodiment, the opening 16f of the arm outer shell 16, which is provided to expose the pivot shaft 2, is closed with the cover 30. That is, even after the connecting of the arm outer shell 16 to the arm head 12, the fixing and removing of the arm head 12 to the pivot shaft 2 can be easily performed through the opening 16f of the arm outer shell 16.

(8) In the present embodiment, the partition wall 30d is provided in the cover 30 to partition between the opening 16f of the arm outer shell 16 and the connecting portion (the connecting pin 29), which is connected with the arm head 12 of the arm outer shell 16. Thus, the partition wall 30d can limit intrusion of, for example, rain water from the opening 16f of the arm outer shell 16 to the connecting pin 29, which serves as the connecting portion of the arm outer shell 16 that is connected with the arm head 12. Therefore, freezing or rusting at the connecting portion by the intruded water can be limited.

### Second Embodiment

A second embodiment of the present invention will be described with reference to the accompanying drawings. Components, which are similar to those of the first embodiment, will be indicated by the same numerals and will not be described further for the sake of simplicity.

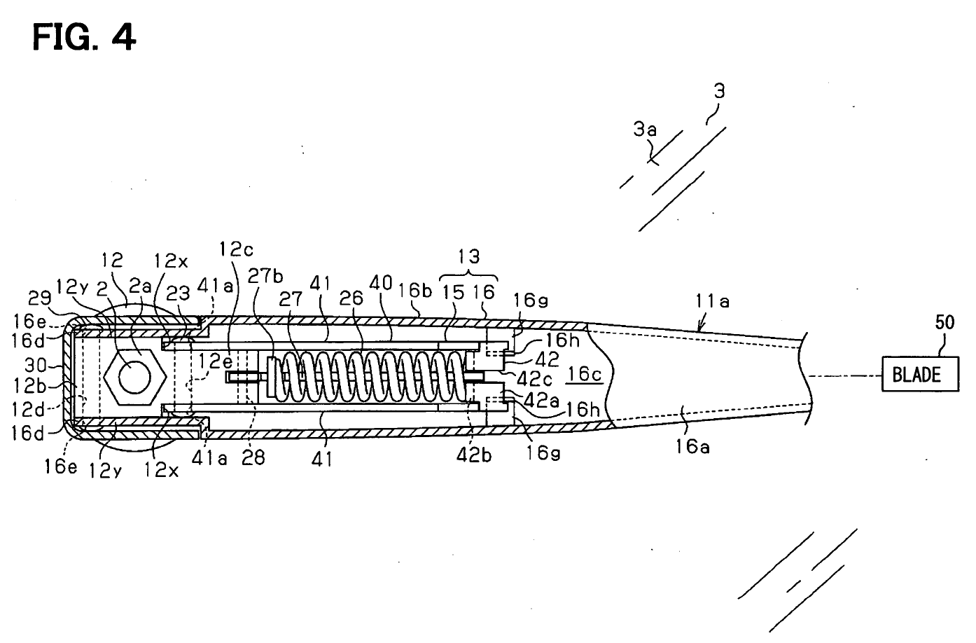

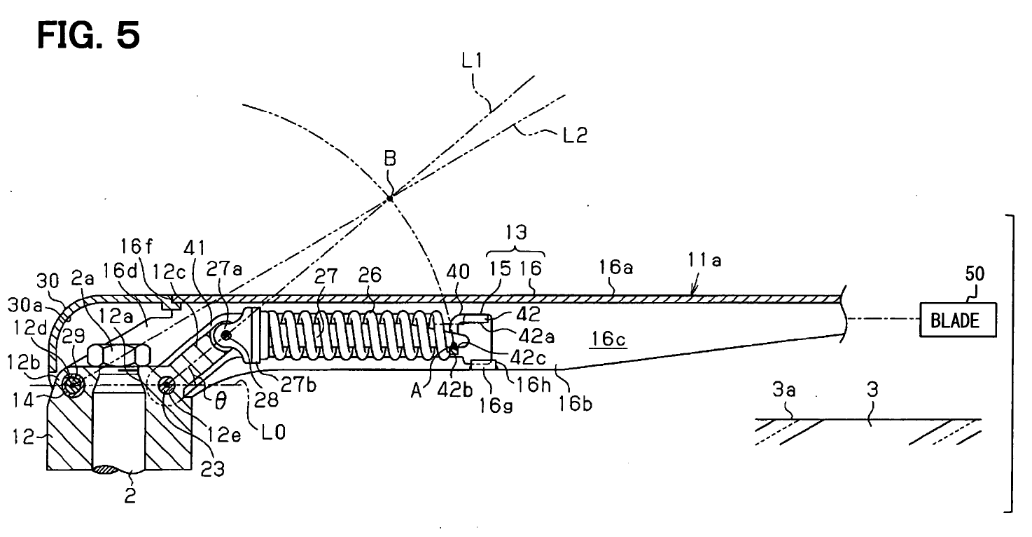

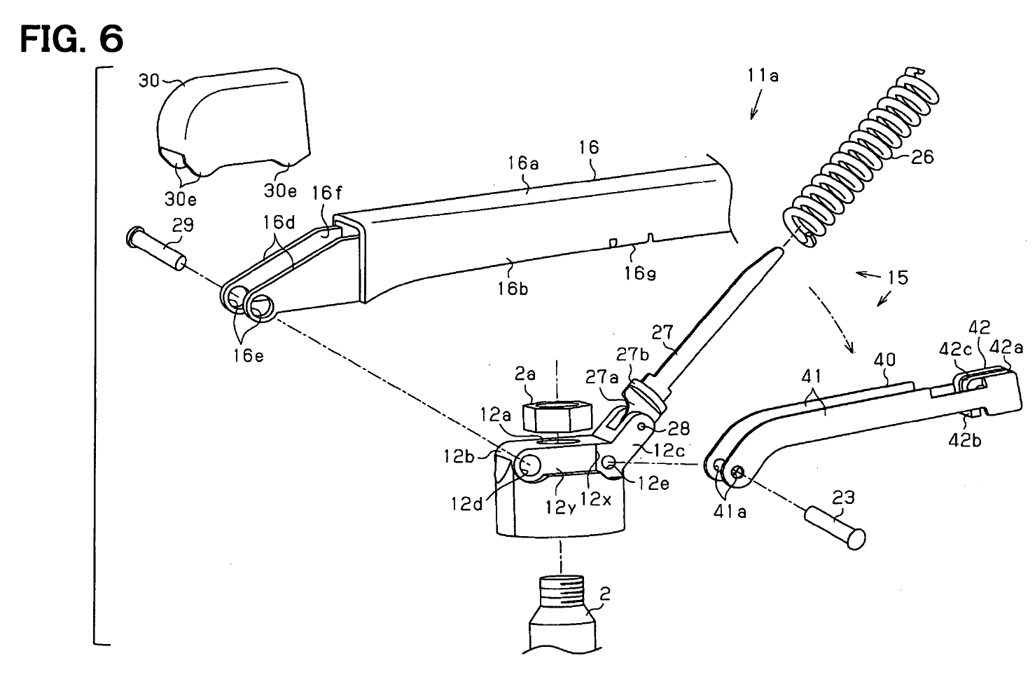

### In the wiper arm 11a of the present embodiment shown in FIGS. 4 to 7, the shape of each of the arm head 12 and the arm main body 13 (the arm mechanism arrangement 15 and the arm outer shell 16) is changed in comparison to that of the first embodiment.

First, a bracket (base member) 40 is provided in the arm mechanism arrangement 15. Two bracket plates 41, which correspond to the bracket plates 21, 22 of the first embodiment, and a stopper portion 42, which corresponds to the stopper 24 and the connecting pin 25, are integrally formed in the bracket 40. The bracket 40 is formed by bending a metal plate, which has been cut into a predetermined shape.

In the bracket 40, the bracket plates 41 are parallel to each other and are opposed to each other in the plate thickness direction of the bracket plates 41, i.e., are opposed to and are spaced from each other in the width direction of the arm outer shell 16. Furthermore, distal end portions of the bracket plates 41 are connected with each other in the width direction by the stopper portion 42. A base end portion of each bracket plate 41 extends obliquely downward, and a connecting hole 41a is formed at an end of the base end portion of the bracket plate 41. The base end portions of the bracket plates 41 are rotatably connected to the connecting hole 12e of the distal end connecting portion 12c of the arm head 12 by the connecting pin 23, which is received through the connecting holes 41a of the bracket plates 41.

Furthermore, the stopper portion 42 of the bracket 40 includes a flat plate portion 42a and a limiting portion 42b to form an inverted L-shaped body. The flat plate portion 42a is bent at a right angle to extend in the width direction at a distal end top portion of each bracket plate 41, and the limiting portion 42b is bent at a right angle to extend downward at base end of the flat plate portion 42a. A linear slit 42c is formed to extend along an entire length of the flat plate portion 42a and also to extend from the top of the limiting portion 42b to a middle of the limiting portion 42b. A distal end portion of the spring guide 27, which is rotatably connected to the arm head 12 at its base end portion through the anchoring pin 28, is inserted from a top side in the slit 42c and is engaged with an end portion of the slit 42c in the limiting portion 42b to limit further downward rotation of the distal end portion of the spring guide 27. The spring 26, which is received over and is supported by the spring guide 27, is installed in the compressed state between the flange 27b of the spring guide 27 and the limiting portion 42b of the stopper portion 42 to urge a distal end portion of the bracket 40 toward the wiping surface 3a side through the limiting portion 42b, i.e., to urge the distal end portion of the arm main body 13 toward the wiping surface 3a side. In the present embodiment, the flange 27b is formed as an annular metal plate, which has an outer diameter that is larger than an outer diameter of a spirally wound coil portion of the spring 26, and which is received over the spring guide 27.

Furthermore, the arm head 12 includes the base end connecting portion 12b and the distal end connecting portion 12c, which are placed on opposite sides, respectively, of the pivot shaft 2. The base end connecting portion 12b includes the connecting hole 12d to connect with the arm outer shell 16. The distal end connecting portion 12c includes the connecting hole 12e and is provided with the anchoring pin 28. The connecting hole 12e is provided to connect with the bracket 40 of the arm mechanism arrangement 15, and the anchoring pin 28 is provided to connect with the spring guide 27. Furthermore, two support surfaces 12y are provided on the opposed lateral sides, respectively, of the base end connecting portion 12b in such a manner that each support surface 12y exists in a corresponding plane where a corresponding peripheral edge of the hole 12d of the base end connecting portion 12b exists and extends to the distal end connecting portion 12c along the corresponding lateral side of the pivot shaft 2. Furthermore, a stepped surface 12x is provided between each support surface 12y and the distal end connecting portion 12c to hold the position of the arm main body 13 at the time of executing the rocking back of the arm main body 13 by limiting the rotation of the bracket 40 in the lifting direction of the bracket 40.

In the arm outer shell 16, the two connecting pieces 16d, which are provided to the base end portion of the arm outer shell 16, are rotatably connected to the base end connecting portion 12b of the arm head 12 through the connecting pins 29. At this time, the connecting pieces 16d are connected to the base end connecting portion 12b in such a manner that the inner surface of each connecting piece 16d is engaged with the corresponding support surface 12y of the arm head 12. Specifically, each connecting piece 16d and the arm head 12 are engaged with each other through the corresponding support surface 12y that has a predetermined surface area to support the arm outer shell 16. In this way, the load of the arm outer shell 16 in the wiping direction can be spread without concentrating the load on the shaft connecting portion between the arm head 12 and the arm outer shell 16. Thus, the durability of the shaft connecting portion can be improved. In other words, the substantial part of the load, which is exerted through the arm outer shell 16 in the wiping direction of the wiper blade 50, is received by the surface-to-surface contacting part between each connecting piece 16d and the corresponding support surface 12y of the arm head 12. Thus, the load, which acts on the connecting pin 29 that connects between the arm outer shell 16 and the arm head 12, can be reduced, so that the durability of the connecting portion can be improved.

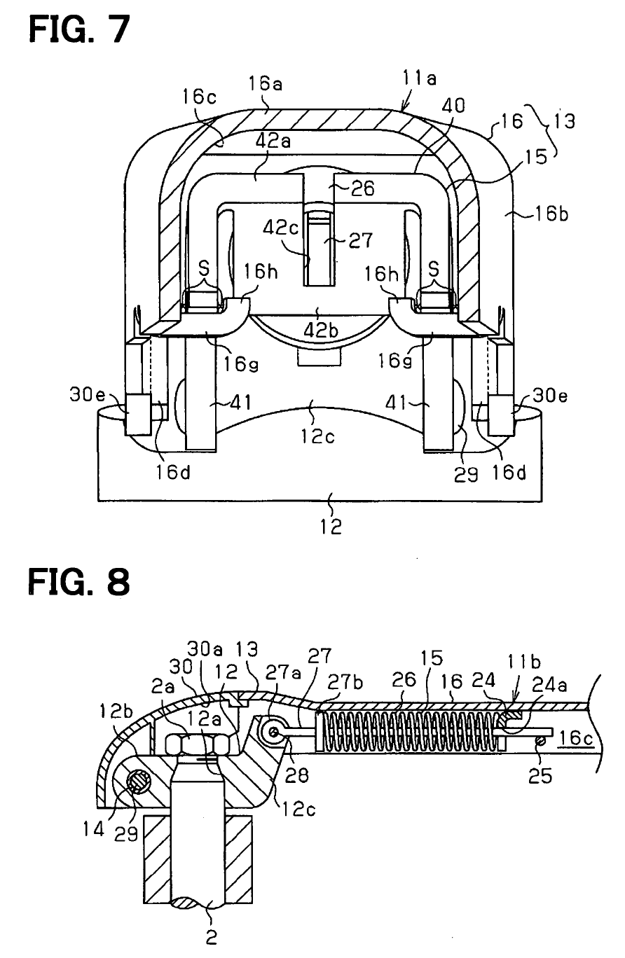

Furthermore, the pressure receiving portions 16g are provided to the lower edges of the lateral walls 16b of the arm outer shell 16 and are bent toward each other in the width direction to engage with the lower edges of the distal end portions of the bracket plates 41. Opposed ends of the pressure receiving portions 16g, which are opposed to each other, are slightly upwardly bent to form guides 16h, respectively. The guides 16h limit falling off of the bracket plates 41 from the pressure receiving portions 16g. Furthermore, as shown in FIG. 7, a predetermined space S is set between each bracket plate 41 and the corresponding guide 16h and also between each bracket plate 41 and the corresponding lateral wall 16b of the arm outer shell 16. That is, at the time of wiping operation, the arm outer shell 16 experiences flexing or twisting in the width direction due to a wiping resistance received by the wiper blade 50. However, when the space S is set between each bracket plate 41 and the guide 16h and between the bracket plate 41 and the lateral wall 16b, small relative movement of the bracket plate 41 in the width direction is permitted. Thus, transmission of the load from the arm outer shell 16 side at the time of flexing or twisting of the arm outer shell 16 is absorbed and is reduced by the relative movement of the bracket plates 41. In this way, while keeping the relatively low strength of the connecting portion of each bracket plate 41, which is implemented by the connecting pin 23, a damage of the connecting portion is well limited. Thus, an increase in the size of each corresponding component can be advantageously limited.

Furthermore, the connecting pieces 16d of the arm outer shell 16 are covered with the cover 30. The cover 30 has four protrusions 30e, each of which has a semicircular shape and extends downward to cover the connecting pin 29, which connects with the arm outer shell 16, and the connecting pin 23, which connects with the bracket 40. When the connecting pins 23, 29 are covered with the protrusions 30e, it is possible to limit the external exposure of the visually undesirably parts of the connecting pins 23, 29, so that the external appearance of the arm outer shell 16 (the arm main body 13) is improved.

The assembling procedure of the wiper arm 11a of the present embodiment will be described. First, the base end portion of the spring guide 27 is rotatably connected to the distal end connecting portion 12c of the arm head 12. Then, the base end portion of the bracket 40, which is placed downward of the spring guide 27, is connected to the distal end connecting portion 12c of the arm head 12 through the connecting pin 23. Thereafter, the spring 26 is inserted over the spring guide 27. At this time, the spring 26 is compressed and is received by the limiting portion 42b of the stopper portion 42 at the distal end side of the bracket 40, and the distal end portion of the spring guide 27 is received in the slit 42c of the stopper portion 42. Thereafter, the connecting pieces 16d of the arm outer shell 16 are connected to the base end connecting portion 12b of the arm head 12 in such a manner that the distal end portion of the bracket 40 is received by the pressure receiving portions 16g of the arm outer shell 16. In this way, the arm main body 13 other than the cover 30 is assembled. Then, the arm head 12 is fixed to the pivot shaft 2 by tightening the nut 2a. Thereafter, the cover 30 is installed to the connecting pieces 16d to cover the connecting pieces 16d.

In the present embodiment, in addition to the advantages described with the first embodiment, the following advantages are provided.

(1) The two bracket plates 41 are integrally formed in the bracket 40 of the arm mechanism arrangement 15. Thus, an increase in the number of components can be advantageously limited. Furthermore, the stopper portion 42, which receives the urging force of the spring 26, is provided in the bracket 40 to connect between the two bracket plates 41. Thus, an increase in the number of components can be limited.

(2) The pressure receiving portions 16g of the arm outer shell 16 are engaged with the arm mechanism arrangement 15 (the bracket plates 41) in such a manner that the relative movement therebetween in the width direction is permitted. At the time of wiping operation, the flexing and twisting in the width direction may occur in the arm outer shell 16 due to the wiping resistance that is received through the wiper blade 50 connected to the distal end portion of the arm outer shell 16. However, the above relative movement absorbs and alleviates the transmission of the load from the arm outer shell 16 side at the time of flexing and twisting of the arm outer shell 16. In this way, while keeping the relatively low strength of the connecting portion of the arm mechanism arrangement 15, which is implemented by the connecting pin 23, a damage of the connecting portion is well limited. Thus, an increase in the size of each corresponding component can be advantageously limited.

The above embodiment may be modified as follows.

In each of the above embodiments, the arm mechanism arrangement 15 is connected to the arm head 12 on the side of the pivot shaft 2 where the distal end portion of the arm main body 13 (i.e., the distal end portion of the arm outer shell 16) is located, and the arm outer shell 16 is connected to the arm head 12 on the opposite side of the pivot shaft 2, which is opposite from the arm mechanism arrangement 15. However, in some cases, it is not necessary to displace the connecting portion between the arm outer shell 16 and the arm head 12 to the opposite side of the pivot shaft 2, which is opposite from the arm mechanism arrangement 15. That is, the arm outer shell 16 may be connected to the arm head 12 on one of the opposed lateral sides of the pivot shaft 2 or on the side of the pivot shaft 2 where the distal end portion of the arm main body 13 is located as long as the arm outer shell 16 is connected to the arm head 12 at a spaced location, which is spaced from the arm mechanism arrangement 15 on a side of the arm mechanism arrangement 15 opposite from the distal end side of the arm main body 13. Even in this way, it is easy to extend the arm outer shell 16 on the side opposite from the arm mechanism arrangement 15. Thus, there is implemented the structure, in which the fixing portion that is fixed to the pivot shaft 2 can be easily covered with the arm outer shell 16.

The structure of the cover 30 may be modified in an appropriate manner in each of the above embodiments. For example, in the first embodiment, the anchoring projection 30b and the fitting portions 30c are provided as the installing means or elements for installing the cover 30. However, the shape, the position and the number of installing means (or elements) may be appropriately changed. Furthermore, the partition wall 30d, which is provided in the interior of the cover 30, may be omitted, if desired. Also, the anchoring projection 30b, the fitting portions 30c and the partition wall 30d of the first embodiment may be applied to the cover 30 of the second embodiment.

In each of the above embodiments, the outer configuration (outer shape) of the arm main body 13 is defined by the two components, i.e., the arm outer shell 16 and the cover 30. Alternatively, for example, a single component (a single arm outer shell forming member) may be used to define the outer configuration of the arm main body 13. Further alternatively, three or more components may be used to define the outer configuration of the arm main body 13.

In the first embodiment, the connecting pins 23, 25 and the stopper 24 are used to connect the bracket plates 21, 22 of the arm mechanism arrangement 15 to the arm head 12 and the spring guide 27. However, the present invention is not limited to this, and any other connecting member(s) may be used. Also, the two bracket plates 21, 22 of the arm mechanism arrangement 15 are plate-shaped. Alternatively, the two bracket plates (bracket elements) 21, 22 of the arm mechanism arrangement 15 may be formed into any other shape other than the plate-shape. Also, the shape of the bracket 40 of the second embodiment may be changed in any appropriate manner.

The wiper arm 11, 11a of each of the above embodiments includes the arm mechanism arrangement 15, which is constructed as the pseudo-arm in the arm outer shell 16. Alternatively, an ordinary arm mechanism arrangement, which is not formed as the pseudo-arm, may be provided in the arm outer shell 16. For example, as in a case of a wiper arm 11b shown in FIG. 8, the bracket plates 21, 22 may be eliminated, and the stopper 24 and the connecting pin 25, which are installed to the bracket plates 21, 22 in the first embodiment, may be directly fixed to the wiper arm 11 side to provide the arm mechanism arrangement 15 shown in FIG. 8. Even in the arm main body 13 of this wiper arm 11b, the spring 26 and the arm head 12 are received in the arm outer shell 16, and the arm outer shell 16 is rotatably connected to the arm head 12 through the connecting pin 29 on the side opposite from the urging spring 26 while the arm main body 13 covers the fixing portion (the fixing hole 12a and therearound) that is fixed to the pivot shaft 2 from the side where the spring 26 is received.

In each of the above embodiments, the compression coil spring 26 is used as the urging means (urging element) for urging the distal end portion of the arm main body 13 toward the wiping surface 3a side. Alternatively, a tension spring may be used in place of the compression spring 26. Furthermore, an urging member other than the coil spring may be used. Also, two or more urging springs 26 may be provided in each of the above embodiments.

Additional advantages and modifications will readily occur to those skilled in the art. The invention in its broader terms is therefore not limited to the specific details, representative apparatus, and illustrative examples shown and described.

What is claimed is:

1. A wiper arm comprising:
an arm head that is adapted to be fixed to a pivot shaft of a vehicle through a fixing portion of the arm head;
an arm main body that is rotatably connected to the arm head at a base end portion of the arm main body and is adapted to be connected with a wiper, blade for wiping a wiping surface at a distal end portion of the arm main body; and
an urging means for urging the distal end portion of the arm main body toward the wiping surface, wherein:
the urging means is provided between the arm head and the arm main body;
the arm main body includes a receiving recess, which receives the urging means and the arm head;
the urging means is placed on a side of the fixing portion of the arm head where the distal end portion of the arm main body is located upon installation of the urging means and the arm head in the receiving recess of the arm main body; and
the arm main body is rotatably connected to the arm head at a location that is spaced from the urging means on a side opposite from the distal end portion of the arm main body.

2. The wiper arm according to claim 1, wherein the arm main body is rotatably connected to the arm head on a side of the fixing portion of the arm head that is opposite from the urging means.

3. The wiper arm according to claim 1, wherein the urging means is a coil spring that is installed in a compressed state between the arm head and the arm main body.

4. A wiper arm comprising:
an arm head that is adapted to be fixed to a pivot shaft of a vehicle through a fixing portion of the arm head;
an arm outer shell forming member that has a receiving recess, which receives the arm head, wherein the arm outer shell forming member is adapted to be connected with a wiper blade for wiping a wiping surface at a distal end portion of the arm outer shell forming member; and
an arm mechanism arrangement that is received in the receiving recess of the arm outer shell forming member together with the arm head and includes:
a bracket that is rotatably connected to the arm head through a connecting member; and
an urging means for urging the distal end portion of the arm outer shell forming member toward the wiping surface, wherein:
the urging means is placed between the arm head and a predetermined portion of the bracket in such a manner that the urging means is placed on a side of the fixing portion of the arm head where the distal end portion of the arm main body is located;
the arm outer shell forming member is connected to the bracket to follow movement of the arm mechanism arrangement while the arm mechanism arrangement and the arm head are received in the receiving recess; and
the arm outer shell forming member is rotatably connected to the arm head at a location that is spaced from the urging means on a side of the urging means, which is opposite from the distal end portion of the arm main body.

5. The wiper arm according to claim 4, wherein the urging means is a coil spring, which is installed in a compressed state between the arm head and the predetermined portion of the bracket.

6. The wiper arm according to claim 4, wherein:
the bracket includes first and second bracket plates, which are provided on two opposed lateral sides, respectively, of a connecting portion of the arm head; and
the first and second bracket plates are connected together by the connecting member or are connected to the arm head by the connecting member.

7. The wiper arm according to claim 6, wherein the urging means is placed between the first and second bracket plates.

8. The wiper arm according to claim 6, wherein the first and second bracket plates are formed integrally in the bracket.

9. The wiper arm according to claim 8, wherein the bracket is formed by bending a metal plate, which is cut into a predetermined shape.

10. The wiper arm according to claim 6, wherein:
the arm outer shell forming member includes:
a top wall; and
first and second lateral walls that extend from lateral edges, respectively, of the top wall toward the wiping surface and form the receiving recess in cooperation with the top wall; and
the first and second bracket plates are supported by the first and second lateral walls of the arm outer shell forming member.

11. The wiper arm according to claim 8, wherein:
the urging means is a coil spring that is placed between the first and second bracket plates; and
the bracket further includes a stopper portion, which receives an urging force of the coil spring and connects between the first and second bracket plates.

12. The wiper arm according to claim 4, wherein the arm outer shell forming member includes a pressure receiving portion, which is placed in the receiving recess and directly or indirectly contacts the arm mechanism arrangement to receive the urging force from the arm mechanism arrangement.

13. The wiper arm according to claim 12, wherein the pressure receiving portion is relatively movable relative to the arm mechanism arrangement in a width direction to engage with the arm mechanism arrangement.

14. The wiper arm according to claim 4, wherein the arm outer shell forming member includes:
an arm outer shell that is rotatably connected to the arm head and has an opening to expose the pivot shaft therefrom; and
a cover that closes the opening of the arm outer shell.

15. The wiper arm according to claim 14, wherein the cover includes a partition wall that partitions between a connecting portion of the arm outer shell, which is connected to the arm head, and the opening of the arm outer shell.

16. A vehicle wiper comprising:
the wiper arm recited in claim 4; and
a wiper blade that is connected to the distal end portion of the arm outer shell forming member of the-wiper arm to wipe the wiping surface.
